(19) United States
(12) Patent Application Publication
(10) Pub. No.: US 2002/0144568 A1
(43) Pub. Date: Oct. 10, 2002

(54) Mini-bicycle handle structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/824,812

(22) Filed: Apr. 4, 2001

(51) Int. Cl. B62K 21/22; B62K 21/12

(52) U.S. Cl. 74/551.7; 74/551.1

(57) ABSTRACT

The present invention relates to a mini-bicycle handle structure having a small section of branch tube being horizontally extended towards the front to connect with the lower section of the vertical tube of the handlebar, and a C-shaped binder being disposed at the front end of the branch tube and coupled to the upper section of the vertical tube of the handlebar, or the front end of the branch tube being integrally fixed to the upper section of the vertical tube of the handlebar, and a protruding ear being formed at the opening end of the C-shape binder for transversally inserting a quick release and forming a short handle by bending both ends of the horizontal bar upward and the horizontal bar is transversally disposed at the upper section of the vertical tube of the handlebar. Such arrangement expands the space between the rider's arm and the grip of the handle and provides a comfortable grip for the rider by extending the handle forward in order to increase the distance between the handle and the rider.

### BACKGROUND OF THE INVENTION

1. Field of the Invention

The present invention relates to a mini-bicycle handle structure, more particularly to a mini-bicycle handle structure having a tube arrangement to extend the handle forward to the front in order to expand the operating space between the rider's arm and the grip of the handlebar, and overcome the problem of insufficient body length of the mini-bicycle.

2. Description of the Prior Art

The bicycle manufacturers have been investing lots of efforts in research and development to constantly produce new products based on the market requirements, and providing more choices of better products to consumers. However, there are many different models depending on its function, and numerous improvements on the part structure. Under the proposition of pursuing entertaining fun, the so-called “Mini-bicycle” is not just for kids, but its design fits all ages. Unlike the ordinary bicycle for kids, the mini-bicycle is a diversified product that fits rider of different ages, and the basic requirement other than the smaller size of the entire body of the frame, a smaller tire is another component that goes with the design. However, since the frame of the mini-bicycle is shortened, the length of its body no longer fits the comfortable ergonomic riding position for adults. Without a special design, the rider has to bend her/his arm to fit the traditional handle that is proximate to the rider's chest. It is inappropriate for the rider to grip the handle of the bike that way.

Due to the architecture of the mini-bicycle handle differs from the traditional handle in that it extends forward and is bent backward from the vertical tube in the front of the bike. Therefore, a novel appropriate handle structure is redesigned for the short body of the mini-bicycle.

In view of the above-mentioned need, the inventor invests in research and development, and invents the handle structure for the mini-bicycle according to the present invention with careful planning and consideration.

### SUMMARY OF INVENTION

The primary objective of the present invention is to provide a mini-bicycle handle structure by extending a tube member forward to facilitate the riders to extend their arms for a natural grip of the bicycle handle, and such structure mainly comprises a small section of branch tube being horizontally extended towards the front to connect with the lower section of the vertical tube of the handlebar, and a C-shaped binder being disposed at the front end of the branch tube and coupled to the upper section of the vertical tube of the handlebar, or the front end of the branch tube being integrally fixed to the upper section of the vertical tube of the handlebar, and a protruding ear being formed at the opening end of the C-shape binder for transversally inserting a quick release and forming a short handle by bending both ends of the horizontal bar upward and the horizontal bar is transversally disposed at the upper section of the vertical tube of the handlebar. Such arrangement expands the space between the rider's arm and the grip of the handle and provides a comfortable grip for the rider by extending the handle forward in order to increase the distance between the handle and the rider.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the structure of the present invention.

FIG. 2 illustrates an embodiment of the present invention when it is in use.

FIG. 3 shows the height adjustment for the handle of the present invention.

FIG. 4 shows the structure of another embodiment of the present invention.

FIG. 5 shows the structure of another embodiment of the present invention.

### DESCRIPTION OF THE PREFERRED EMBODIMENT

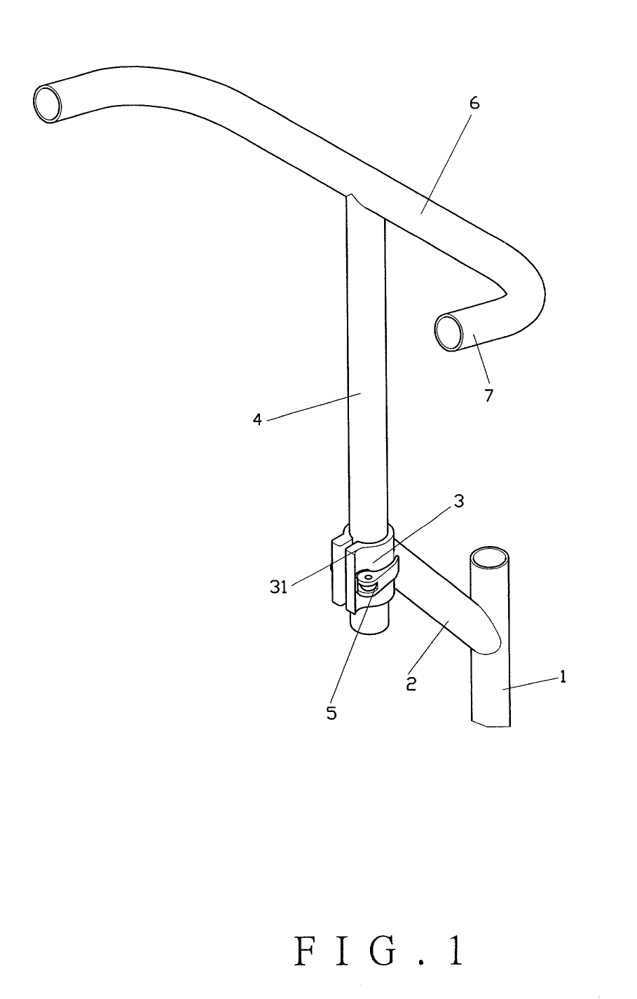

Please refer to FIG. 1, which shows the feasible handle structure of a preferred embodiment of the present invention, and its design is described below.

The handle structure of the present invention comprises a small section of a branch tube (2) being horizontally extended forward to connect with the lower section of a vertical tube (1) of the handlebar, and a C-shaped binder (3) with an opening being disposed at the front end of the branch tube (2) and coupled to the upper section of the vertical tube (4) of the handlebar, wherein the c-shape binder (3) forms a protruding ear (31) at the opening end of the C-shape binder for transversally inserting a quick release (5) for the locking by pressing. Further, the vertical tube (4) at the upper section of the handle is transversally coupled to a horizontal handlebar (6) and both ends of the horizontal handlebar are bent to form a section of short grip (7). Such short grip (7) could be tilted upward slightly.

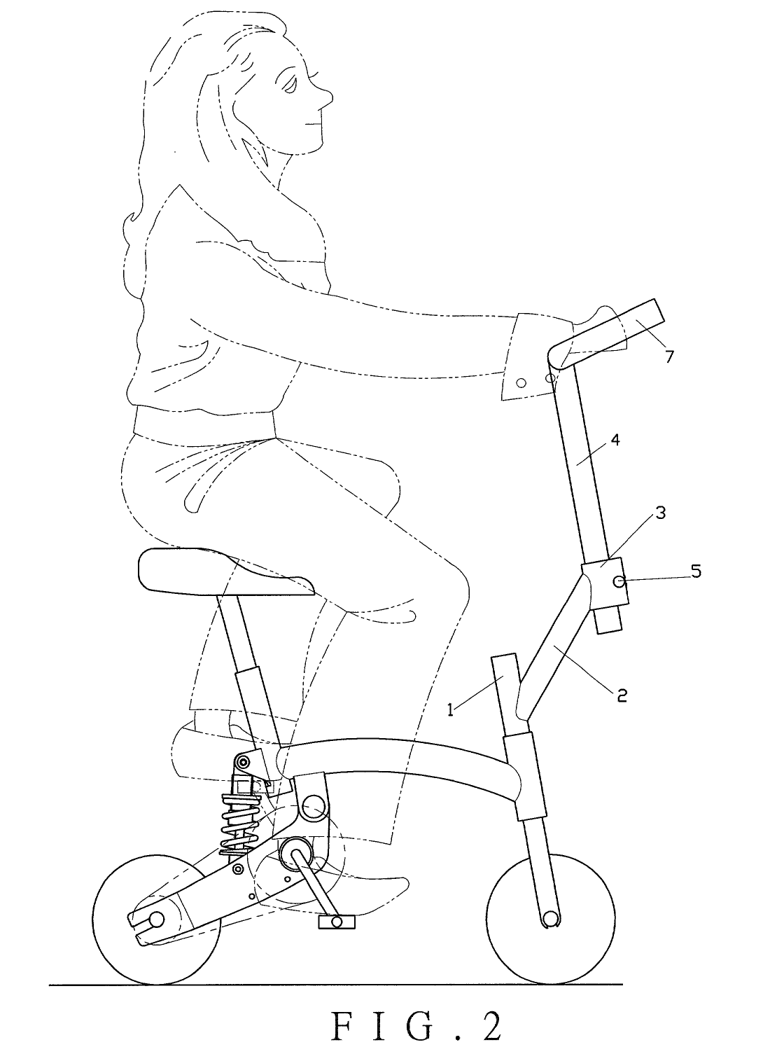

By means of installing the above special handle structure to the turning mechanism at the front end of the mini-bicycle, as shown in FIG. 2, the vertical tube (1) at the lower section of the handle is coupled to the turning device connected to the front of the mini-bicycle, and a small section of the horizontal branch tube (2) is extended to the front, and the horizontal handlebar (6) is bent at its ends to form short grips (7). The design of the entire handle structure increases the distance between the rider and the grip (7) and provides adequate space for riders to extend their arm for an appropriate grip. The rider can ride the bike while sitting straight on the rear seat, and stretching her/his arm naturally, and having no need to bend the arm intentionally. Such arrangement meets the ergonomic requirements for a comfortable riding position, and the rider is able to hold the grip (7) at the utmost front end by her/his palm.

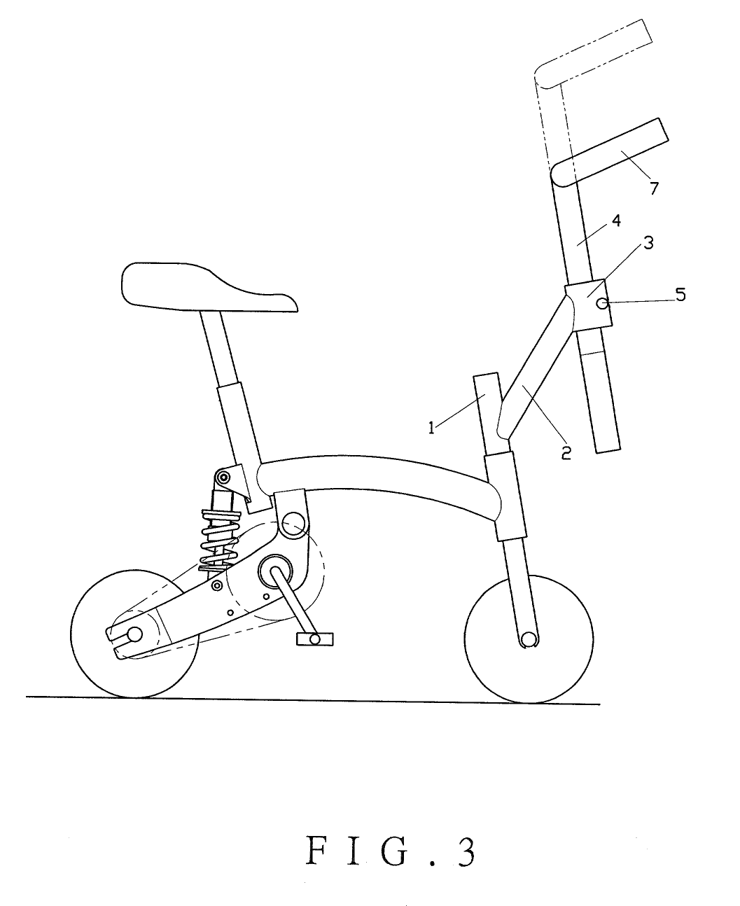

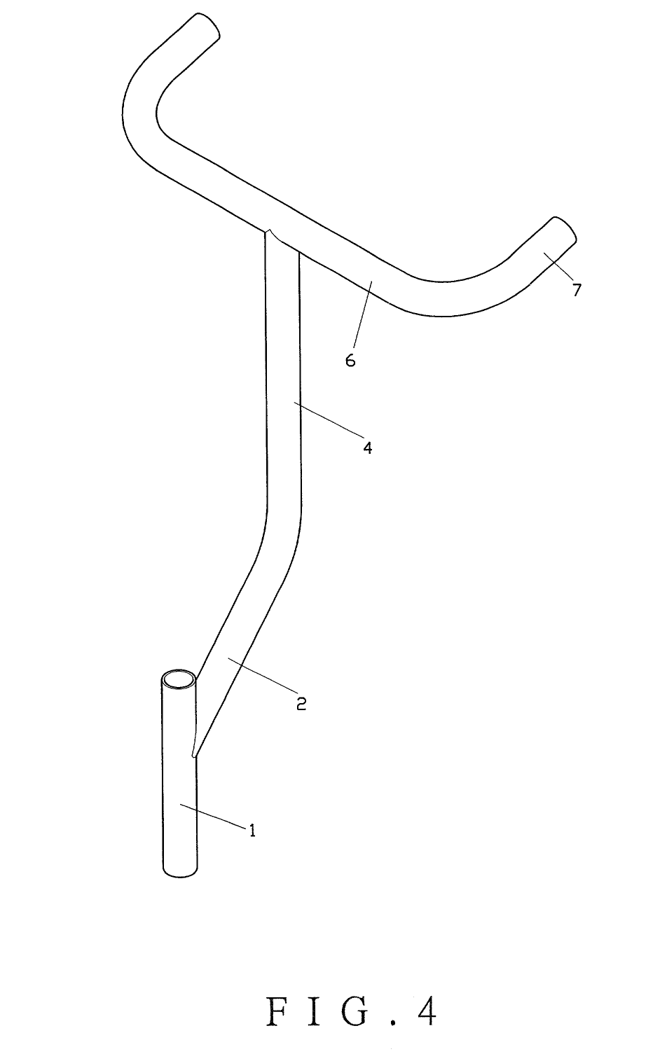

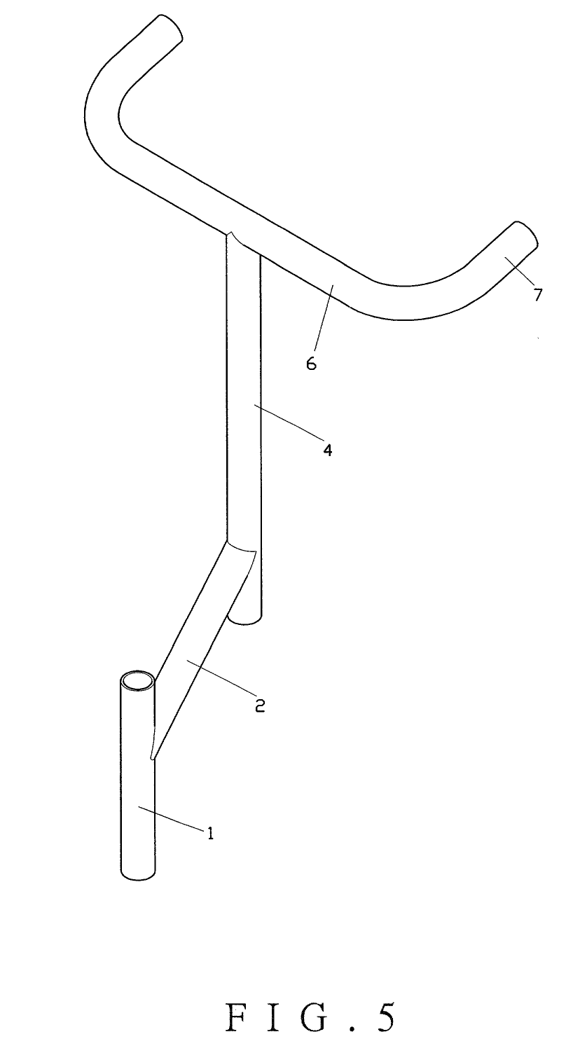

Furthermore, the above embodiment as shown in FIG. 3 makes use of the vertical tube (4) at the upper section of the handlebar by passing it through a binder (3) at the front end and tightly lock the mechanically coupling with a quick release (5) to attain the function of adjusting the height of the handlebar. However, such active structure is not the only way of achieving the objective of the present invention. As shown in FIG. 4, the front end of the branch tube (2) couples to the vertical tube at the upper section of the handlebar and integrally form a curved tube, or as shown in FIG. 5, the front end of the vertical tube at the upper section of the handlebar is integrally soldered to the handlebar.

As described above, the handle structure of the mini-bicycle of the present invention is innovative and more advantageous than the conventional handle structure by expanding the space between the rider's arm and the grip of the handle and providing a comfortable grip for the rider by extending the handle forward in order to increase the distance between the handle and the rider. It definitely overcomes the problem of the insufficient body length of the mini-bicycle. The present invention complies with the patent application requirements and hence is submitted to the Patent and Trademark Office for review and the granting of the commensurate patent.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mini-bicycle handle structure, comprising a small section of a horizontal branch tube being extended forward and coupled with the lower section of a vertical tube of a handlebar, and the upper section of the vertical tube being transversally coupled to the horizontal section of the handle, and both ends of the horizontal tube are bent upward to form a shorter gripping section.

2. A mini-bicycle handle structure of claim 1, wherein said branch tube has a c-shape binder with an opening at its front end for coupling to the upper section of the vertical tube of the handlebar, and the opening end of the binder forms a protruding ear at the opening end to transversally insert and mount a quick release.

3. A mini-bicycle handle structure of claim 1, wherein said branch tube having its front end coupled to the upper section of the vertical tube to form an integrally curve structure.

4. A mini-bicycle handle structure of claim 1, wherein said branch tube having its front end soldered onto the upper section of the vertical tube to form an integrally curve structure.

5. A mini-bicycle handle structure of claim 1, wherein said handle having both ends of its horizontal tube bent forward to form a tilted upward gripping section.
